(19) United States
(12) Patent Application Publication
(10) Pub. No.: US 2024/0098523 A1
(43) Pub. Date: Mar. 21, 2024

(54) METHOD, CENTRAL UNIT, DISTRIBUTED UNIT, BASE STATION

(71) Applicant: NEC Corporation, Minato-ku, Tokyo (JP)

(72) Inventors: Chadi KHIRALLAH, Epsom (GB); Sadafuku KAYASHI, Tokyo (JP); Stanislav FILIN, Stanislav (JP)

(73) Assignee: NEC Corporation, Minato-ku, Tokyo (JP)

(21) Appl. No.: 18/271,168

(22) PCT Filed: Jan. 7, 2022
(86) PCT No.: PCT/JP2022/000430

§ 371 Date: Jul. 6, 2023

(30) Foreign Application Priority Data
Jan. 14, 2021 (GB) 2100492.4

(51) Int. Cl. H04W 24/02; H04B 17/336; H04W 24/10

(52) U.S. Cl. CPC H04W 24/02; H04B 17/336; H04W 24/10

(57) ABSTRACT

A method is presented in which a central unit (5-2b) of a split base station apparatus in a cellular communication system sends, to a distributed unit (5-2a) of the split base station apparatus, a first message comprising an information element for configuring the distributed unit (5-2a) of the split base station apparatus serving a UE (3) to report current measurement data representative of communication quality measurements. The central unit (5-2b) receives, from the distributed unit (5-2a) of the split base station apparatus, in a second message sent in response to the first message, communication quality measurements for the cell and/or beam currently serving the UE (3) under control of the distributed unit (5-2a) of the split base station apparatus.

### TECHNICAL FIELD

The present invention relates to mobile communications devices and networks.

### BACKGROUND ART

The present invention relates to mobile communications devices and networks, particularly but not exclusively those operating according to the 3rd Generation Partnership Project (3GPP) standards, or equivalents or derivatives thereof. The invention has particular although not exclusive reference to so-called ‘4th Generation’, ‘4G’ (or ‘LTE’) systems, ‘fifth generation’, ‘5G’ (or ‘Next Generation/New Radio’) systems, and derivatives and hybrid configurations of such systems, including Dual Connectivity (DC) configurations, Multi-Radio Access Technology (multi-RAT) Dual Connectivity (MR-DC) configurations such as Evolved UMTS Terrestrial Radio Access (E-UTRA) New Radio (NR) Dual Connectivity (EN-DC), and other similar configurations.

The latest developments of the 3GPP standards are referred to as the Long Term Evolution (LTE) of Evolved Packet Core (EPC) network and Evolved UMTS Terrestrial Radio Access Network (EUTRAN), also commonly referred to as ‘4G’. In addition, the term ‘5G’ and ‘New Radio’ (NR) refer to an evolving communication technology that is expected to support a variety of applications and services such as Machine Type Communication (MTC), Internet of Things (IoT) communications, vehicular communications and autonomous cars, high resolution video streaming, smart city services, and/or the like. Accordingly, 5G technologies are expected to enable network access to vertical markets and support network (RAN) sharing for offering networking services to third parties and for creating new business opportunities. 3GPP intends to support 5G by way of the so-called 3GPP Next Generation (NextGen) radio access network (RAN) and the 3GPP NextGen Core (NGC) network (also referred to as the ‘5G core’ (5GC). Various details of 5G networks are described in, for example, the ‘NGMN 5G White Paper 2’ by the Next Generation Mobile Networks (NGMN) Alliance, which document is available from https://www.ngmn.org/5g-white-paper-2.html.

In order to access the wider communication network, user communication devices (user equipment or ‘UEs’) connect to the network (4G and/or 5G) via radio access network (RAN) equipment comprising one or more base stations. A base station associated with a 4G network is typically referred to as an evolved NodeB (′eNB) whereas a base station associated with a 5G network may be referred to as a New Radio Base Station (‘NR-BS’) or as a ‘gNB’. It will be appreciated, however, that such RAN apparatus/base stations may sometimes be referred to using alternative or interchangeable terms. For example, 5G base stations may sometimes be referred to as eNBs (or 5G/NR eNBs), a term which is more typically associated with LTE base stations.

To meet the requirements of high system capacity and coverage of the 5G network, ultra-dense networks (of nodes) are considered to be key; and, for a densely deployed small cell network, self-optimization is crucial for reducing the cost of network and capacity optimization. A split architecture (between central and distributed units) has been proposed that allows for coordination of performance features, load management, and real-time performance optimization. Accordingly, the functionality of a gNB (referred to herein as a ‘distributed gNB’) may be split between one or more Distributed Units (‘DUs’ or ‘gNB-DUs’) and a Central Unit (‘CU’ or ‘gNB-CU’), with a CU typically performing higher level functions and communication with the CUs of other distributed gNBs in the network (via an Xn interface) and with the next generation core, with the DU performing lower level functions and communication over an air interface with user equipment (UE) in the vicinity (i.e. in a cell operated by the gNB), wherein communication between the DUs and their associated CU is performed via F1 AP signalling and messages.

In a recent release of the 3GPP Technical Specification, 3GPP TS 38.401 V16.4.0, the overall architecture for a distributed gNB is set out in more detail. A ‘split gNB’ architecture is proposed, wherein the CU is also split into a Control Plane gNB-CU (‘gnB-CU CP’) and one or multiple User Plane gNB-CUs (‘gNB-CU UP’). The or each gNB-CU UP is connected to the gNB-CU CP via an E1 interface. The gNB-CU CP is connected to each of one or multiple gNB-DUs through an F1-C interface, and the or each gNB-CU UP is connected to each of the gNB-DUs via an F1-U interface.

The concept of Self-Organizing Networks (SONs) was standardized by 3GPP in relation to the LTE network specification, and continues to be a priority for 5G networks. A key element of SON development is known as Capacity and Coverage Optimization (CCO), which allows the system to periodically adapt to changes in traffic (i.e. load and location), and the radio environment, by automatically adjusting coverage for the cells that serve a certain area for a particular traffic situation, and some solutions for this provision have been proposed, that use collected data in the form of UE measurements, performance measurements, events and other monitoring information, also taking into account beamforming and massive MIMO (Multiple-Input Multiple-Output)-related information.

### SUMMARY OF INVENTION

### Technical Problem

In 3GPP TR 37.816 V16.0.0, it is highlighted that coverage ‘holes’ with unbalanced DL (Downlink) and UL (Uplink) channel coverage require consideration. Two specific use cases are set forth, as follows:

Use Case 1: Coverage Problems

This use case focuses on scenarios where the coverage of reference signals is sub-optimal, leaving the UE expose to failures or degraded performance, e.g. when a coverage hole is found or where UL/DL disparity is encountered. It is worth noticing that MRO will take care of all types of failures due to wrong mobility settings within a network with good cell planning. That implies that CCO should address cases where the root cause of the problem is due to a bad coverage planning.

Use Case 2: Capacity Problems

Within this class some cases were found where capacity within a cell or beam is saturated, resulting in one or more UEs being subject to failures or suboptimal performance. There are a number of reasons for such an event, such as high demand of services, which exceeds resources available in the cell/beam or poor radio conditions affecting a large share of served UEs *for example where a large number of UEs is at cell edge, causing high interference to other UEs and consuming large amounts of resources.

In addition, it is noted that Mobility Load Balancing (MLB), which involves load transfer from an overloaded cell to under-loaded neighbouring cells, will take care of load distribution via mobility and that such mobility load balancing is performed mainly in inter-frequency scenarios, i.e. where cross-cell interference is not an issue. That implies that CCO should address cases where the root cause of the problem is due to serving UEs at cell/beam edge, where the “edge” is between cells/beams utilising the same resources. Capacity optimization issues that can arise as a result of cross-cell interference include:
poor radio conditions at the cell edge resulting in inefficient usage of resources by cell-edge UEs; and
even when highly directional antennas are used for different UEs, if two or more UEs, served by different gNBs, are located at a cell edge, close to each other, they may not be able to communicate in DL and UL at the same time due to interference.

The present invention aims to provide methods, apparatus and a communication system that address or at least partially ameliorate the above issues.

The present invention is set out in the appended independent claims. Optional features are set out in the appended dependent claims.

### Solution to Problem

According to one aspect of the present invention, there is provided a method performed by a central unit of a split base station apparatus in a cellular communication system, the method comprising: sending, to a distributed unit, DU, of the split base station apparatus that serves a user equipment, UE, a first message comprising an information element, IE, for configuring the distributed unit of the split base station apparatus to report current measurement data representative of communication quality measurements; and receiving, from the distributed unit of the split base station apparatus, in a second message sent in response to the first message, communication quality measurements for the cell and/or beam currently serving the UE under control of the split unit of the distributed base station apparatus.

According to one aspect, there is provided a central unit of a split base station apparatus of a cellular communication system, the central unit comprising means for sending, to a distributed unit, DU, of the split base station apparatus that serves a user equipment, UE, a first message comprising an information element, IE, for configuring the distributed unit of the split base station apparatus to report current measurement data representative of communication quality measurements; and means for receiving, from the distributed unit of the split base station apparatus, in a second message sent in response to the first message, communication quality measurements for the cell and/or beam currently serving the UE under control of the distributed unit of the split base station apparatus.

According to one aspect, there is provided a distributed unit, DU, of a split base station apparatus that serves a user equipment, UE, in a cellular communication system, the distributed unit comprising means for receiving, from a central unit of the split base station apparatus, a first message comprising an information element, IE, for configuring the distributed unit to report current measurement data representative of communication quality measurements; and means for sending, to the central unit in response to the first message, a second message containing data representative of communication quality measurements for the cell and/or beam currently serving the UE under control of the distributed unit.

According to one aspect, there is provided a method performed by a distributed unit of a split base station of a cellular communication system, the method comprising: receiving, from a central unit of the split base station apparatus, a first message comprising an information element, IE, for configuring the distributed unit to report current measurement data representative of communication quality measurements; and sending, to the central unit in response to the first message, a second message containing data representative of communication quality measurements for the cell and/or beam currently serving the UE under control of the distributed unit.

Aspects of the invention extend to corresponding systems, apparatus, computer program products such as computer readable storage media having instructions stored thereon which are operable to program a programmable processor to carry out a method as described in the aspects and possibilities set out above or recited in the claims and/or to program a suitably adapted computer to provide apparatus recited in any of the claims.

Each feature disclosed in this specification (which term includes the claims) and/or shown in the drawings may be incorporated in the invention independently of (or in combination with) any other disclosed and/or illustrated features. In particular, but without limitation, the features of any of the claims dependent from a particular independent claim may be introduced into that independent claims, in any combination or individually.

Although for efficiency of understanding for those of skill in the art, the invention will be described in detail in the context of a 3GPP system (5G networks), the principles of the invention can be applied to other systems in which Capacity and Coverage Optimization is performed.

### Advantageous Effects of Invention

According to the present disclosure, it is possible to provide methods, apparatus and a communication system that address or at least partially ameliorate the above issues.

### BRIEF DESCRIPTION OF DRAWINGS

Embodiments of the invention will now be described, by way of example, with reference to the accompanying drawings, in which:

FIG. 1 illustrates schematically a mobile (cellular or wireless) telecommunication system to which embodiments of the invention may be applied;

FIG. 2A is a schematic block diagram illustrating a ‘split’ gNB architecture, as specified in the 3GPP Technical Specification (TS) 38.401;

FIG. 2B is a schematic block diagram illustrating a split gNB as defined in the 3GPP Technical Specification (TS) 38.401;

FIG. 3 is a simplified schematic block diagram of a mobile device forming part of the system shown in FIG. 1;

FIG. 4 is a simplified block diagram of a split gNB forming part of the system of FIG. 1;

FIG. 5A illustrates examples of the types of interference that can occur with a split gNB;

FIG. 5B illustrates examples of the types of interference that can occur with a split gNB;

FIG. 5C illustrates examples of the types of interference that can occur with a split gNB;

FIG. 5D illustrates examples of the types of interference that can occur with a split gNB;

FIG. 6 is a flow chart illustrating an exemplary procedure for use in a communication system shown in FIG. 1;

FIG. 7 is a simplified signalling diagram for the GNB-CU CONFIGURATION UPDATE messaging used in the procedure illustrated in FIG. 6;

FIG. 8 is a simplified signalling diagram for a CCO procedure according to the procedure described generally in relation to FIG. 6;

FIG. 9 is a flow diagram illustrating another exemplary procedure for use in a communication system shown in FIG. 1; and

FIG. 10 is a simplified signalling diagram for a CCO procedure according to the procedure described generally in relation to FIG. 9.

### DESCRIPTION OF EMBODIMENTS

Overview

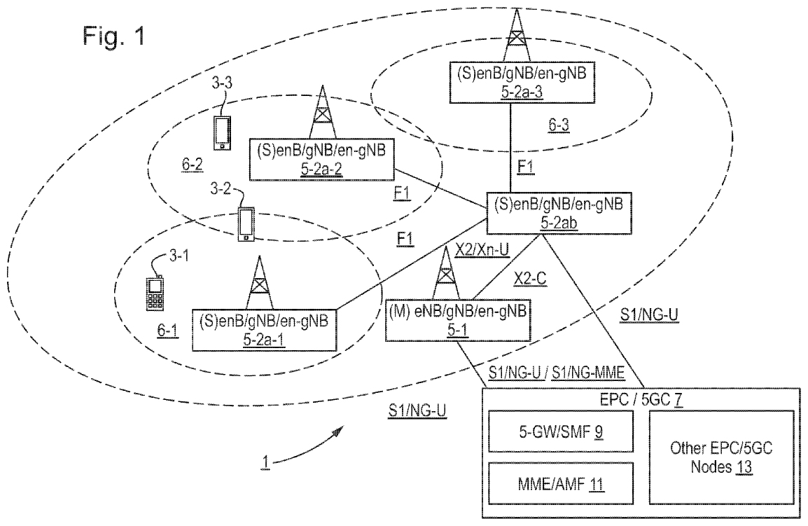

FIG. 1 illustrates schematically a mobile (cellular or wireless) telecommunication system 1 to which embodiments of the invention may be applied.

In the telecommunication system 1, items of user equipment (UEs) 3-1, 302, 3-3 can communicate with one another and other UEs via respective base stations 5-1-, 5-2 and a core network 7 using an appropriate 3GPP radio access technology (RAT), for example, am E-UTRA and/or 5G RAT. It will be appreciated that a number of base stations 5 form a (radio) access network or (R)AN. Those skilled in the art will appreciate, whilst three mobile devices 3 and two base stations 5 are shown in FIG. 1 for illustration purposes, the system, when implemented, will typically include other base stations and UEs.

The core network 7, in this example, comprises an evolved packet core (EPC) or 5G Core (5GC). The core network 7 includes a serving gateway (S-GW) or Session Management Function (SMF) 9 and a mobility management entity (MME) or Access and Mobility Function(AMF) 11, in addition to other EPC or 5GC nodes 13 that are well understood in the art.

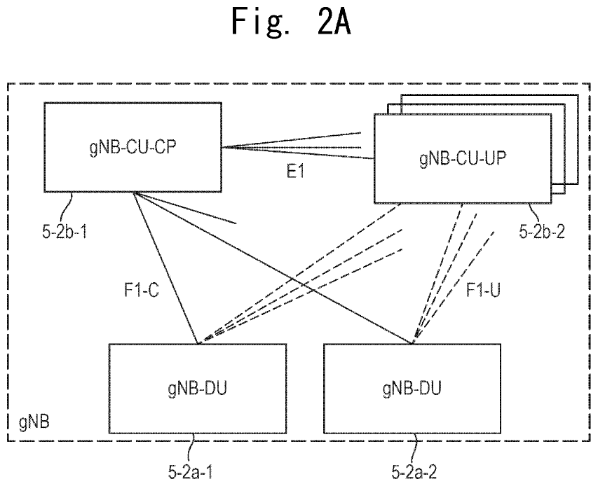

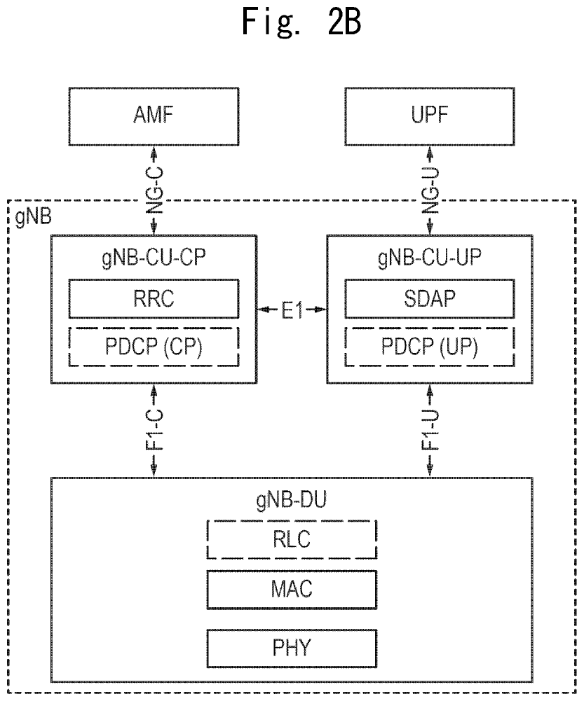

The base stations 5 comprise or include base stations (gNBs) configured to operate in accordance with 4G or 5G standards. In this example, at least one of the base stations 5-2 comprises a distributed gNB 5-2 having a central unit (gNB-CU) 5-2b and a plurality of distributed units (gNB-DUs) 5-2a-1 to 5-2a-3, each of which serves at least one associated cell 6-1 to 6-3 respectively. The central and distributed units of the gNB 5-2 communicate with one another over a dedicated interface (know as the F1 or F1 application protocol ‘F1AP’ interface). Indeed, and as will be illustrated hereinafter, the central unit (gNB-CU) may be ‘split’, such that the distributed gNB may comprise a Control Plane central unit (gNB-CU-CP) 5-2b1 and one or more User Plane central units (gNB-CU-UP) 5-2b-1, as well as the plurality of distributed units (gNB-DUs) 5-2a-1 to 5-2a-3. As illustrated schematically in FIG. 2A of the drawings, the gNB-CU-CP 5-2b-1 and gNB-CU-UP 5-2b-2 communicate with each other over a dedicated interface (known as the ‘E1’ interface), the gNB-CU-CP 5-2b-1 communicates with the gNB-DUs 5-2a-1 to 5-2a3 via the F1AP (control plane) an the gNB-DUs can communicate with the gNB-CU-UP 5-2b-2 via a F1AP interface.

Referring to FIG. 2B of the drawings, there is illustrated schematically a distributed gNB as defined in the 3GPP Technical Specification (TS) 38.401. The definitions provided therein are as follows:

gNB Central Unit (gNB-CU): a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU.

gNB Distributed Unit (gNB-DU): a logical node hosting rlc, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

Each UE 3 and its serving base station (or serving base station DU) 5 are connected via an appropriate air interface (for example, the so-called ‘Uu’ interface and/or the like).

As the UEs move through the communication system, they can obtain and send measurement reports (MR) to the central unit gNB-CU (of their serving base station). The measurement report contains data indicative or representative of network quality in relation to the quality of service being experienced by that UE, and will be familiar to a person skilled in the art. These measurement reports may be sent periodically and/or upon request by the gNB-CU.

User Equipment (UE)

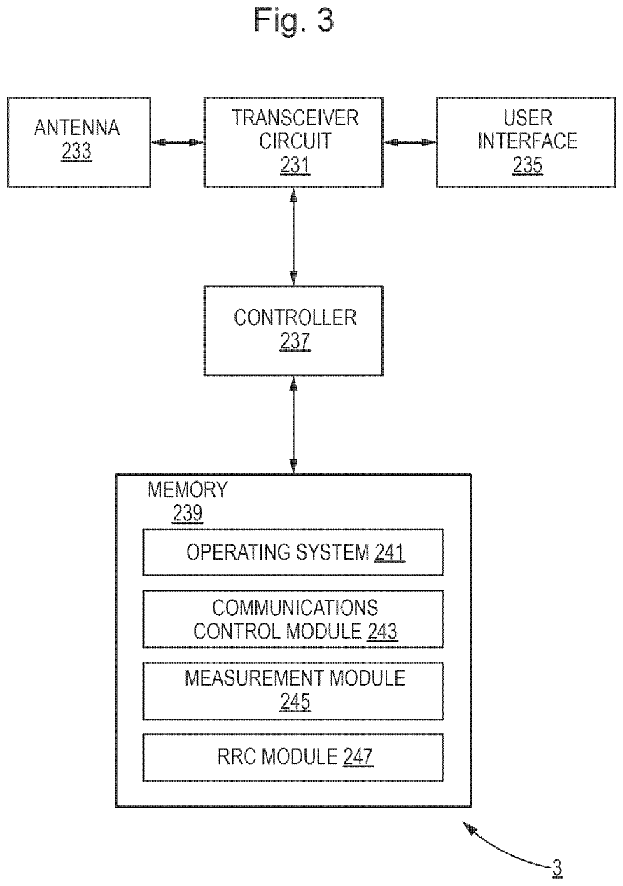

FIG. 3 is a block diagram illustrating the main components of user equipment (UE) 3 suitable for the communication system 1 shown in FIG. 1.

As shown, the UE 3 includes a transceiver circuit 231 which is operable to transmit signals to, and receive signals from, the connected node(s) via one or more antennas 233. Although not necessarily shown in FIG. 2A, the UE will of course have all the usual functionality of a conventional mobile device (such as a user interface 235) and this may be provided by one or any combination of hardware, software and firmware, as appropriate.

A controller 237 controls the operation of the UE in accordance with software stored in a memory 239. The software may be pre-installed in the memory 239 and/or may be downloaded via the telecommunication system 1 or from a removable data storage device (RMD), for example.

The software includes, among other things, an operating system 241, a communications control module 243, a measurement module 245 and an RRC module.

The communications control module 243 is operable to control the communication between the UE 3 and the base stations 5. The communications control module 243 also controls the separate flows of uplink data and control data that are to be transmitted to the base station(s) 5 and the reception of downlink data and control data transmitted by the base station(s) 5. The communications control module 243 is responsible, for example, for managing the UE's part in idle and connected mode procedures such as cell (re)selection, camping on cells, listening for system information, random access channel (RACH) procedures, etc.

The measurement module 245 handles the performance of measurements of communication conditions (e.g. received signal power and quality) in the serving and neighbouring cells (e.g. based on measurement configuration and control information received from the base station 5). The measurement module 245 also generates associated measurement reports (MRs) for transmission to the base station.

Distributed or “Split” Base Station (gNB)

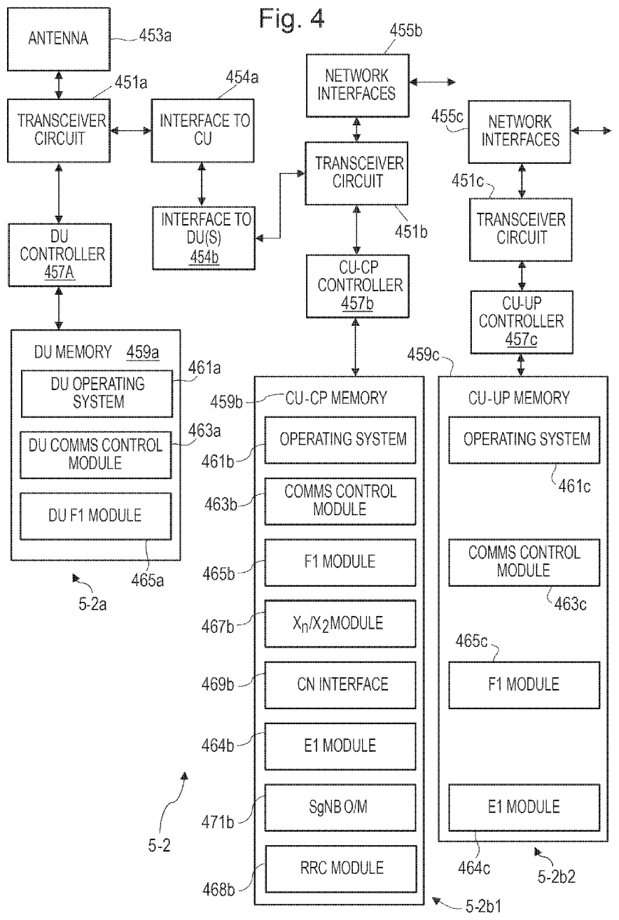

FIG. 4 is a block diagram illustrating the main components of a distributed type gNB 5-2 of the type shown in FIGS. 1 and 2A.

As shown, the gNB 5-2 includes at least one distributed unit 5-2a, a control plane central unit 5-2b1 and at least one user plane central unit 5-2b2. Each unit 5-2a, 5-2b1 and 5-2b2 includes respective transceiver circuitry 451a, 451b, 451c. The distributed unit 5-2a transceiver circuitry 451a is operable to transmit signals to, and receive signals from, UEs 3 via one or more antennas 453a and is operable to transmit signals to, and to receive signals from, the control plane central unit 5-2b1 via an interface 454a.

The control plane central unit 5-2b1 transceiver circuitry 451b is operable to transmit signals to, and to receive signals from, functions of the core network 7 and/or other gNBs 5 via network interfaces 456b. The network interfaces typically include a base station to core network interface (e.g. an s1-U interface) for communicating with the core network 7, and one or more base station to base station interfaces (Xn/X2 interfaces) for communicating with other base stations. The control plane central unit 5-2b1 transceiver circuitry 451b is also operable to transmit signals to one or more distributed units 5-2a via an interface 454b (e.g. the F1-C interface). The user plane central unit 5-2b2 transceiver circuitry 451c is operable to receive signals from one or more distributed units 5-2a via an interface 454c (e.g. the F1-U interface). The transceiver circuitry 451b of the control plane central unit 5-2b1 and the transceiver circuitry 451c of the user plane central unit 5-2b2 are also operable to transmit signals to, and receive signals from, each other via, for example, an E1 interface.

Each unit 5-2a, 5-2b1 and 5-2b2 includes a respective controller 457a, 457b, 457c which controls the operation of the corresponding transceiver circuitry 451a, 451b, 451c in accordance with software stored in the respective memories 459a, 459b, 459c of the distributed unit 5-2a, the control plane central unit 5-2b1 and the user plane central unit 5-2b2. The software of each unit includes, amongst other things, a respective operating system 461a, 461b, 461c, a respective communications control module 463a, 463b, 463c, and a respective F1 module 465a, 465b, 465c. The control plane central unit 5-2b1 includes an Xn/X2 module 467b, a CN interface module 469b and an SgNB operation module 471b. Both central units 5-2b1 and 5-2b2 include a respective E1 module 464b. The central unit 5-2a includes an RRC module 468b.

Each communications control module 463a, 463b, 463c is operable to control the communication of its corresponding unit 5-2a, 5-2b1, 5-2b2 including communication from one unit to the other. The communications control module 463a of the distributed unit 5-2a controls communication between the distributed unit 5-2a and the UEs 3, and the communications control module 463b of the control plane central unit 5-2b1 controls communication between the control plane central unit 5-2b1 and any other network entities that are connected to the gNB 5-2.

Each of the communications control modules 463a, 463b, 463c also respectively controls the part played by the distributed unit 5-2a and the two central units 5-2b1, 5-2b2 in the flow of uplink and downlink user traffic to be transmitted to and received from the UEs 3 served by gNB 5-2. Each communications module 463a, 463b, 463c is responsible, for example, for controlling the respective part played by the distributed unit 5-2a and the two central units 5-2b1, 5-2b2 in procedures such as the communication of measurement control/configuration information, system information, the gNBs part in the random access channel (RACH) procedures, etc. Furthermore, each communications control module 463a, 463b, 463c is also responsible, for example, for controlling the respective part played by the distributed unit 5-2a and the two central units 5-2b1, 5-2b2 in managing the gNBs part in the setup, configuration and reconfiguration of gNB to gNB interfaces with neighbouring gNBs, and also its part in mobility procedures including making mobility decisions, selecting targets, etc. (where applicable).

Each of the F1 modules 465a, 465b, 465c is responsible for the management of traffic over the central unit and the distributed unit (F1) interface between the distributed unit 5-2a and the central unit 5-2b1, 5-2b2 (under the overall; control of the corresponding communications control modules (463a, 463b, 463c).

The Xn/X2 module 467b of the control plane central unit 5-2b1 is responsible for the management of the gNB's traffic over the base station to base station interface(s) (under the overall control of the communications control module 463b).

The CN interface module 469b of the control plane central unit 5-2b1 is responsible for the management of the gNB's traffic over the base station to core network interface under the overall control of the communications control module 463b).

The SgNB operation module 471b of the control plane central unit 5-2b1 is responsible for managing the operation of the gNB 5-2 as a secondary gNB (where applicable).

The RRC module 468b of the control plane central unit 5-2b1 is responsible for controlling the RRC layer functionality of the gNB 5-2 and corresponding RRC communication with the UE 3 (under overall control of the communications control module 463b).

Capacity and Coverage Optimization (CCO)

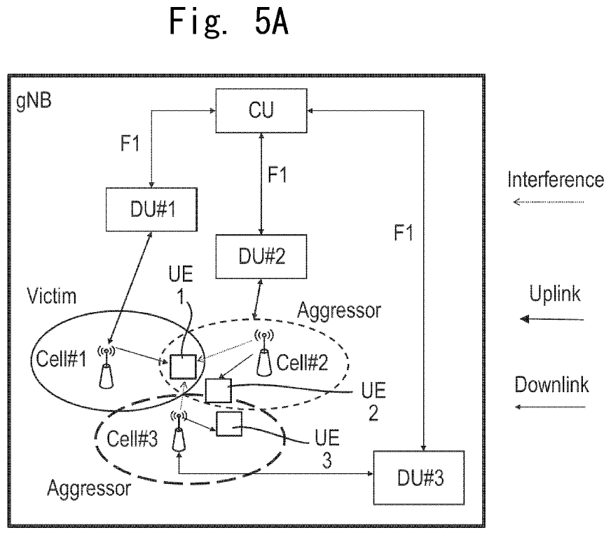

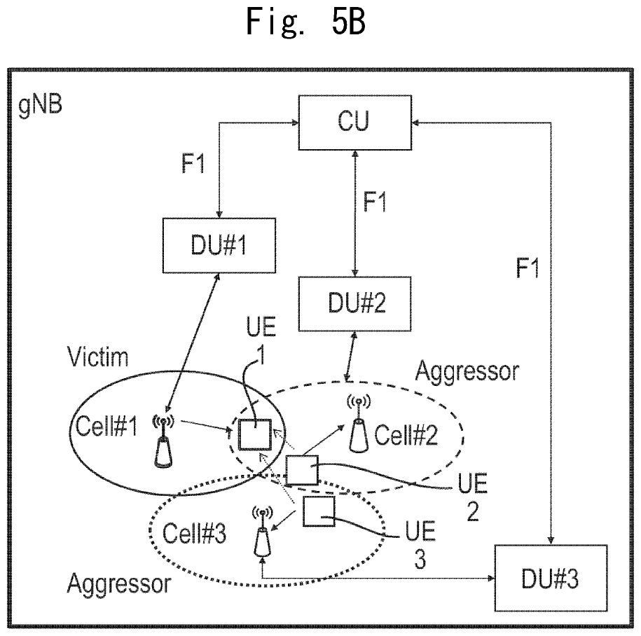

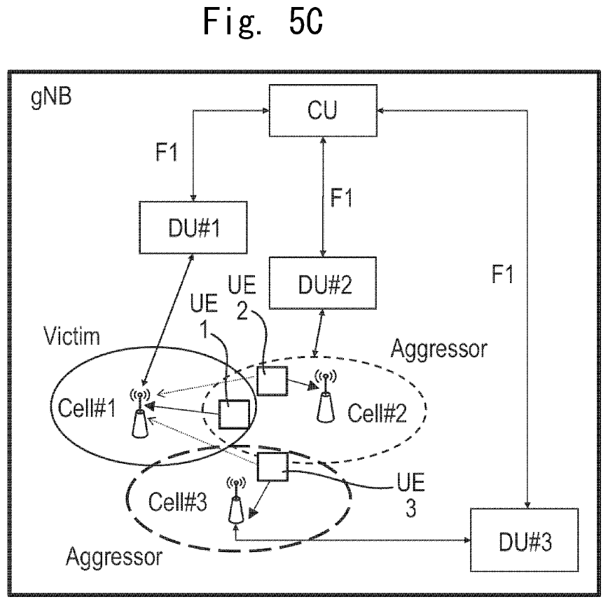

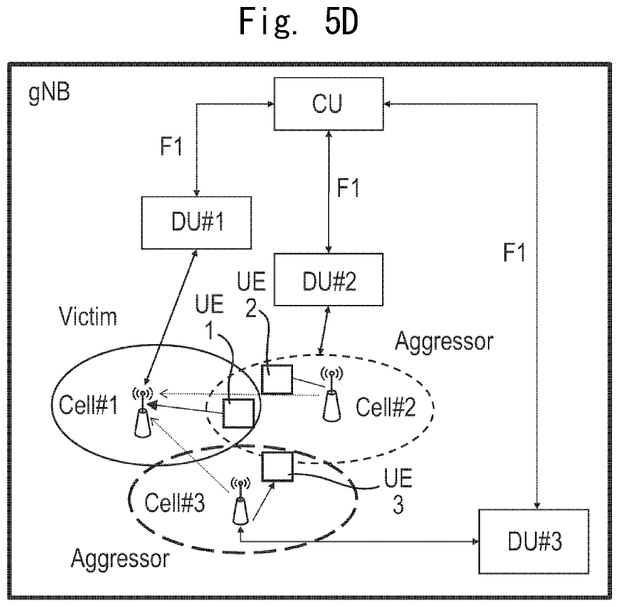

As explained above, in order to implement an effective Capacity and Coverage (CCO) provision, it is necessary to address cases where the root cause of the problem is due to serving UEs at cell/beam edge, where the “edge” is between cell beams utilizing the same resources, as set out above in the Use Case 2. To aid understanding of the following description, and referring to FIGS. 5A, 5B, 5C and 5D of the drawings, examples of the types of interference that can occur with a split gNB are illustrated schematically. FIG. 5A illustrates a first Inter-DU intra-CU interference case, wherein Downlink (DL) interference comes from other DUs. During DL transmissions to UE1 in Cell #1 (victim) which belongs to DU #1, UE1 may experience interference from DL transmissions in Cell #2 and Cell #3 (aggressors), which are under the control of DU #2 and DU #3 respectively. FIG. 5B illustrates another inter-DU Intra-CU interference case, wherein DL interference comes from other UEs. During DL transmissions to UE1 in Cell #1 (victim) which belongs to DU #1, UE1 may experience interference from UE2 and UE3 uplink (UL) transmissions in Cell #2 and Cell #3 (aggressors) which are under control of DU #2 and DU #3 respectively. FIG. 5C illustrates a first inter-DU intra-CU interference case, wherein UL interference comes from other UEs. During UL transmission by UE1 in Cell #1 (victim) which belongs to DU #1, UE1 may experience interference from UE2 and UE3 UL transmissions in Cell #2 and Cell #3 (aggressors), which under the control of DU #2 and DU #3 respectively. FIG. 5D illustrates another inter-DU intra-CU interference case in which UL interference comes from other DUs, but this case is addressed by other management propositions and will not be considered any further herein. Yet another example of interference in a split gNB is an inter-DU inter-CU interference case wherein the aggressor neighbouring cells, causing DL/UL interference to the victim cell may belong to DUs under the control of different CUs/gNBs. In this case, and in order to address the problem, coordination over F1 and Xn interfaces is required.

Procedures will now be described, by way of example only, which may be implemented to enhance CCO provisions in a communications system, and which may at least partially ameliorate the problems caused by the types of interference considered above. However, it is to be understood that the cases considered and described in relation to FIGS. 5A, 5B and 5C are intended to be purely illustrative of the types of interference conditions that can occur in communication systems having a split gNB architecture, and the techniques described below may have a number of additional and/or alternative benefits.

### Example 1

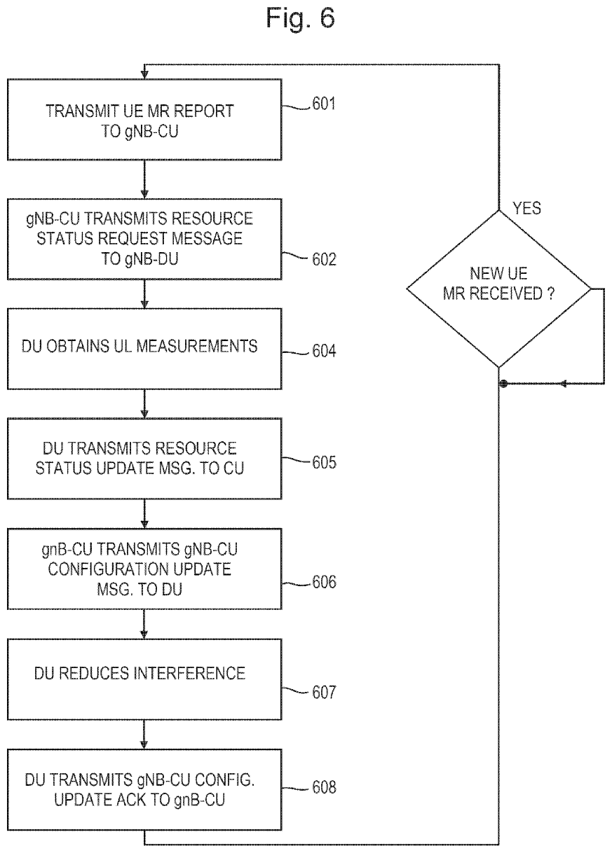

An example method is illustrated schematically in the form of a flow chart in FIG. 6 of the drawings.

As explained above, in a communication system utilizing the split gNB architecture, the UEs communicate with gNB-DUs via an appropriate air interface (such as the so-called ‘Uu’ interface or the like). It is known, within the context of CCO implementation, for each UE to periodically generate a respective measurement report (MR) and transmit the MR to the serving gNB-CU. The UE MR is composed of, or derived from, measurements performed by the UE in the context of indicating network quality. The UE reports, to the gNB-CU, measurements at cell-level and/or beam-level from SS/PBCH blocks and/or CSI-RS (RSRP, RSRQ or SINR) for instance. As an example, the UE may determine values for the DL-SINR (signal to interference signal to noise ratio) and/or the DL-RSSI (received signal strength indicator) at beam/cell level and report the measurements (in the form of, or with, a Channel Quality Indicator (CQI)), at step 601, to the CU of the serving gNB. It will be appreciated by a person skilled in the art that other network quality measurements may be used, performed or reported by the UE(s), and the present invention is not necessarily intended to be limited in this regard.

At step 602, the serving gNB-CU configures the serving gNB-DU to report UL (uplink) measurements. This is achieved by F1AP signalling by the gNB-CU to the serving gNB-DU. Specifically, the gNB-CU transmits a RESOURCE STATUS REQUEST message and acts to configure the gNB-DU to report beam/cell level UL measurements (for cell edge or for all UEs in the cell). The format of the RESOURCE STATUS REQUEST message is illustrated below, showing information elements (IEs) that maybe included.

### Resource Status Request Message

| | | | | | |
|---|---|---|---|---|---|
| Report Characteristics | C- | BIT STRING | Each position in the bitmap | YES | ignore |
| | ifRegistration | (SIZE(32)) | indicates measurement | | |
| | RequestStart | | object the gNB-DU is | | |
| | | | requested to report. | | |
| | | | First Bit = PRB Periodic, | | |
| | | | Second Bit = TNL Capacity | | |
| | | | Ind Periodic, | | |
| | | | Third Bit = | | |
| | | | Composite Available Capacity | | |
| | | | Periodic, Fourth Bit = HW | | |
| | | | LoadInd Periodic, Fifth Bit = | | |
| | | | Number of Active UEs | | |
| | | | Sixth Bit = report beam-level | | |
| | | | measurement, | | |
| | | | Seven Bit = report cell-level | | |
| | | | measurement, | | |
| | | | Other bits shall be ignored | | |
| | | | by the gNB-DU. | | |

At step 604, the gNB-DU obtains or retrieves cell- and/or beam-level UL (uplink) measurements and reports these, at step 605, back to the gNB-CU in a RESOURCE STATUS UPDATE message, for example, having a format such as that illustrated below.

| | | | | | | |
|---|---|---|---|---|---|---|
| Cell Measurement Result | | 0 . . . 1 | | | YES | ignore |
| >Cell Measurement Result | | 1 . . . <maxCellingNBDU> | | | — | |
| Item | | | | | | |
| >>Cell ID | M | | NR CGI | | — | |
| | | | 9.3.1.12 | | | |
| >>>Cell-Level | O | | | | — | |
| Measurement | | | | | | |
| >>>>SINR | M | | Range of values | | — | |
| >>>>Signal Level | M | | Range of values | | — | |
| >>> Measured Beam List | O | 0 . . . <maxnoofmeasSSBs> | | | — | |
| >>>> SSB Index | M | | INTEGER (0 . . . 63) | | — | |
| >>>>> UEs List | M | 0 . . . <maxnoofUEsperSSB> | | | — | |
| >>>>>> UE ID | M | | C-RNTI | | — | |
| >>>>>>> Beam-Level | M | | | Interference and | — | |
| Measurement | | | | signal level related | | |
| | | | | measurements, e.g. | | |
| | | | | based on SRS signal. | | |
| >>>>>>>> SINR | M | | Range of values | | — | |
| >>>>>>>> Signal Level | M | | Range of values | | — | |
| >>>>>>>> Other | M | | Range of values | e.g. CRC, BER | — | |
| parameters | | | | estimation, etc. | | |

e.g. range of values SINR, SINR_0 to SINR_127, mapped to −23 to 40 dB

The UL measurements reported to the gNB-CU may comprise:
per UE, beam-level measurements, e.g. SRS measurements; and/or
cell-level measurement, calculated as the average of the beam-level measurements for UEs in the cell. Optionally, this average may be based only on cell-edge UE(s), which may be selected based on beam level measurements below a predetermined threshold (e.g. absThresholdSRS).

Using the UE CQI (or DL DINR or SINR-like measurements) received from the UE and the signal level measurements (at cell/beam level) received from the gNB-DU, the gNB-CU computes an overall interference level in each cell/beam and transmits, at step 606, to the gNB-DU, a GNB-CU CONFIGURATION UPDATE message which contains data representative of the above-mentioned interference level. In this regard, two alternative scenarios are considered:

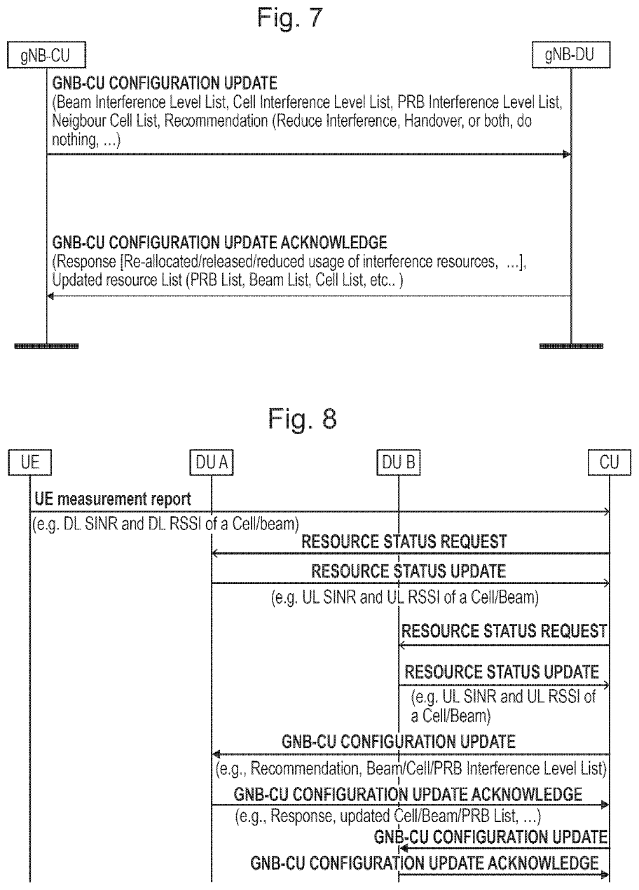

Alt1: new IEs “Cell Interference level List”, “Beam Interference level List”, and/or “PRB Interference level list” included in the gNB-CU CONFIGURATION UPDATE message over F1, as shown in FIG. 7 of the drawings.
Optionally, gNB-CU also sends the overall interference level in neighboring cells/beams

Alt2: gNB-CU sends only to certain gNB-DUs a list of their cells/beams, with interference level above a given threshold.
Optionally, gNB-CU also sends the overall interference level in neighboring cells/beams

At step 607, each gNB-DU may try to reduce interference in its cells/beams by, for example:
reshuffling resource blocks allocation in this cell/beam;
reducing amount of allocated resource blocks in this cell/beam;
optionally, the gNB-DU may avoid using the PRBs with highest level of interference (if list of such PRBs is received from gNB-CU).

Finally, at step 608, the gNB-DU may respond to the gNB-CU with a message as confirmation of, for example, interference reduction (or other action) having been effected. For example, a GNB-CU CONFIGURATION UPDATE ACKNOWLEDGE message may be send by the gNB-DU to the gNB-CU over F1, that includes the CellID/SSB Block Index and data indicative of a reduced interference level. A simplified signalling diagram illustrating the GNB-CU CONFIGURATION UPDATE and GNB-CU CONFIGURATION UPDATE ACKNOWLEDGE procedure described above is provided in FIG. 7 of the drawings. A simplified signalling diagram illustrating the method described above with reference to FIG. 6 is provided in FIG. 8 of the drawings.

### Example 2

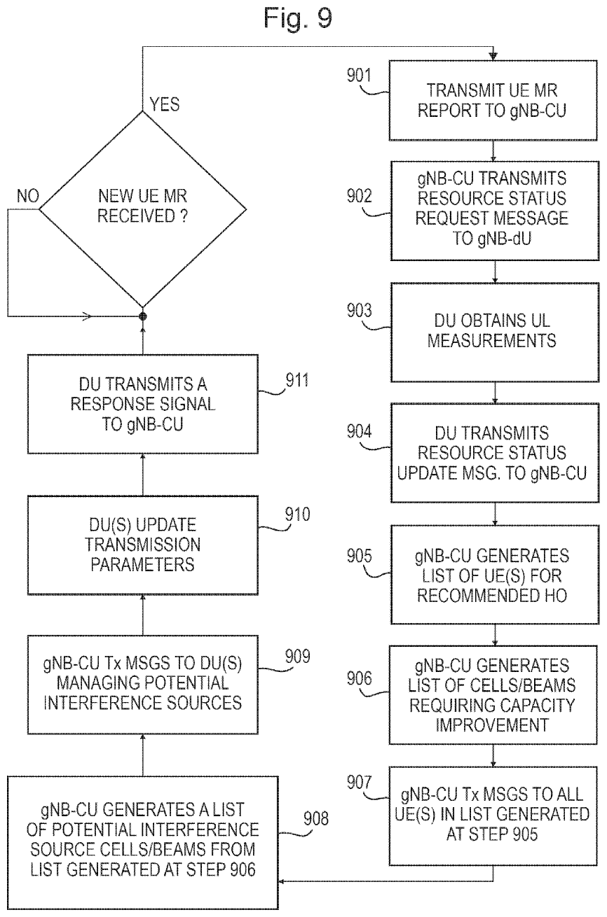

In an alternative example, and referring to FIG. 9 of the drawings, the first three steps are similar to those performed in the procedure of Example 1. Thus, the procedure starts with the UEs performing, for example, DL SINR (or SINR-like) and signal-level related measurements on cell/beam level, and reporting them (at step 901) as UE MRs to their respective serving gNB-CUs.

At step 902, the gNB-CU configures the gNB-DU, by transmitting a RESOURCE STATUS REQUEST message at step 902, to report UL measurements:
per UE, beam-level measurements, e.g. SRS measurements; and/or
cell-level measurement, calculated as the average of the beam-level measurements for UEs in the cell (and, optionally, the average could be based only on cell-edge UE(s), which may be selected based on beam-level measurement values below a predetermined threshold, e.g. absThresholdSRS)).

A suitable format for the RESOURCE STATUS REQUEST message is illustrated below:

### Resource Status Request Message

| | | | | | |
|---|---|---|---|---|---|
| Report Characteristics | C- | BIT STRING | Each position in the bitmap | YES | ignore |
| | ifRegistration | (SIZE(32)) | indicates measurement | | |
| | RequestStart | | object the gNB-DU is | | |
| | | | requested to report. | | |
| | | | First Bit = PRB Periodic, | | |
| | | | Second Bit = TNL Capacity | | |
| | | | Ind Periodic, | | |
| | | | Third Bit = | | |
| | | | Composite Available Capacity | | |
| | | | Periodic, Fourth Bit = HW | | |
| | | | LoadInd Periodic, Fifth Bit = | | |
| | | | Number of Active UEs | | |
| | | | Sixth Bit = report beam-level | | |
| | | | measurement, | | |
| | | | Seven Bit = report cell-level | | |
| | | | measurement, | | |
| | | | Other bits shall be ignored | | |
| | | | by the gNB-DU. | | |

The gNB-DU obtains and/or retrieves the UL measurements at step 903 and, at step 904, transmits a RESOURCE STATUS UPDATE message back to the serving gNB-CU, that includes the cell and/or beam level measurement results. A suitable format for the RESOURCE STATUS UPDATE message is shown below:

| | | | | | | |
|---|---|---|---|---|---|---|
| Cell Measurement Result | | 0 . . . 1 | | | YES | ignore |
| >Cell Measurement Result | | 1 . . . <maxCellingNBDU> | | | — | |
| Item | | | | | | |
| >>Cell ID | M | | NR CGI | | — | |
| | | | 9.3.1.12 | | | |
| >>>Cell-Level | O | | | | — | |
| Measurement | | | | | | |
| >>>>SINR | M | | Range of values | | — | |
| >>>>Signal Level | M | | Range of values | | — | |
| >>> Measured Beam List | O | 0 . . . <maxnoofmeasSSBs> | | | — | |
| >>>> SSB Index | M | | INTEGER (0 . . . 63) | | — | |
| >>>>> UEs List | M | 0 . . . <maxnoofUEsperSSB> | | | — | |
| >>>>>> UE ID | M | | C-RNTI | | — | |
| >>>>>>> Beam-Level | M | | | Interference and | — | |
| Measurement | | | | signal level related | | |
| | | | | measurements, e.g. | | |
| | | | | based on SRS signal. | | |
| >>>>>>>> SINR | M | | Range of values | | — | |
| >>>>>>>> Signal Level | M | | Range of values | | — | |
| >>>>>>>> Other | M | | Range of values | e.g. CRC, BER | — | |
| parameters | | | | estimation, etc. | | |

e.g. range of values SINR, SINR_0 to SINR 127, mapped to −23 to 40 dB

At step 905, based on the received measurements, the gNB-CU generates a list of UEs for which a handover (HO) is recommended. At step 906, the gNB-CU generates a list of cells/beams that require capacity improvement.

At step 907, the gNB-CU generates and transmits messages to all of the UEs on the list generated in step 905 recommending that a HO is performed. At step 908, for each cell/beam from the list of cells/beams generated at step 906, the gNB-CU generates a list of potential interference source cells/beams.

At step 909, the gNB-CU transmits a message including a recommendation for interference reduction (or other actions, e.g. HO) to the gNB-DUs managing the cells/beams on the list of potential interference source cell/beams generated in step 908. Optionally, the recommendation for interference reduction may include an indication of level interference (similar to example 1 above) and/or it may also optionally include the list of PRBs with highest level interference (e.g. in the form of a “PRB Interference Level List”). At step 910, gNB-DUs that have received a recommendation for, for example, interference reduction, act to update transmission parameters of the potential interference cell list indicated in the recommendation of interference reduction. Examples of possible actions in this regard will be apparent to a person skilled in the art, and include:
reshuffling resource block allocation in the current cell/beam;
reducing the amount of allocated resource blocks in the current cell/beam;
optionally, the gNB-DU can avoid using the PRBs with the highest levels of interference (if a list of such PRBs is received from the gNB-CU).

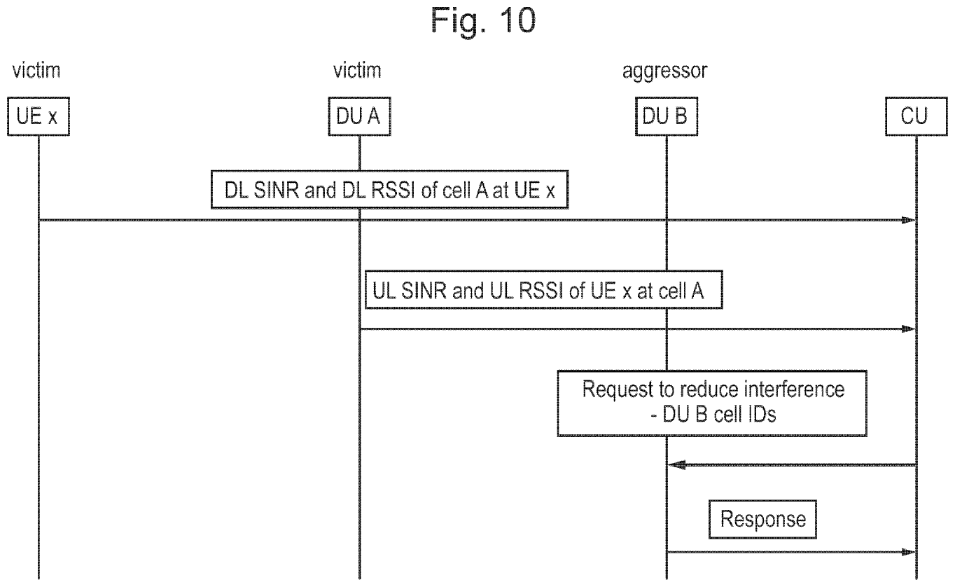

Finally, at step 911, the gNB-DU may transmit a RESPONSE signal to the gNB-CU to confirm what, if any, action to reduce interference has been taken (or other actions, e.g. HO). A simplified signalling diagram illustrating the above-described process is provided in FIG. 10 of the drawings.

In either of the two examples described above, if the cells/DUs are under control of different CUs/NG-RAN nodes, then each CU/NG-RAN node may exchange (over Xn) a list of cells that require interference reduction (or other actions, e.g. HO).

Various other modifications will be apparent to those skilled in the art and will not be described in further detail herein.

The whole or part of the embodiments disclosed above can be described as, but not limited to, the following supplementary notes.

### (Supplementary Note 1)

A method performed by a central unit of a split base station apparatus in a cellular communication system, the method comprising: sending, to a distributed unit of the split base station apparatus that serves a user equipment, UE, a first message comprising an information element, IE, for configuring the distributed unit of the split base station apparatus to report current measurement data representative of communication quality measurements; and receiving, from the distributed unit of the split base station apparatus, in a second message sent in response to the first message, communication quality measurements for the cell and/or beam currently serving the UE under control of the distributed unit of the split base station apparatus.

### (Supplementary Note 2)

The method according to Supplementary note 1, wherein the communication quality measurements include or comprise uplink, UL, communication measurements.

### (Supplementary Note 3)

The method according to Supplementary note 1 or Supplementary note 2, wherein the first message comprises a request message, and the second message comprises a specific response message for responding to that request message.

### (Supplementary Note 4)

The method according to Supplementary note 3, wherein the first message comprises a resource status request message and the second message comprises a corresponding resource status update message for responding to the resource status request message.

### (Supplementary Note 5)

The method according to Supplementary note 4, wherein the resource status request message and the corresponding resource status update message are messages of an application protocol, AP, specific to an interface between the central unit and distributed unit of the split base station apparatus.

### (Supplementary Note 6)

The method according to any of the preceding Supplementary notes, wherein the resource status request message comprises an information element, IE, having multiple bits including at least one bit that is set to ‘true’ to request the distributed unit of the split base station apparatus to provide current communication quality measurement data.

### (Supplementary Note 7)

The method according to Supplementary note 6, wherein a first bit of the IE is set to ‘true’ to request the distributed unit of the split base station apparatus to provide current communication quality measurement data at beam level, and a second bit of the IE is set to ‘true’ to request the distributed unit of the split base station apparatus to provide current communication quality measurement data at cell level.

### (Supplementary Note 8)

The method according to any of the preceding Supplementary notes, wherein the resource status update message comprises information elements, IEs, for defining a communication quality measurement value; and, optionally, wherein at least one of the resource status update message IEs comprises data representative of signal-to-interference signal-to-noise ratio, SINR, associated with a communication channel of the UE and obtained at signal-level, beam-level and/or cell-level.

### (Supplementary Note 9)

The method according to any of the preceding Supplementary notes, wherein the first message is sent in response to receipt, by the central unit of the split base station apparatus, of a UE measurement report, MR, from the UE.

### (Supplementary Note 10)

The method according to any of the preceding Supplementary notes, further comprising using one or more communication quality measurement values received in the second message from the distributed unit of the split base station apparatus to determine an overall interference level in each cell and/or beam currently under control of that distributed unit of the split base station apparatus.

### (Supplementary Note 11)

The method according to Supplementary note 10, comprising determining an overall interference level in one or more neighbouring cells and/or beams.

### (Supplementary Note 12)

The method according to Supplementary note 10 or Supplementary note 11, further comprising sending, to the distributed unit of the split base station apparatus, a third message comprising an information element, IE, defining a cell interference level list, a beam interference level list and/or a PRB interference level list; and, optionally, further comprising sending the third message to the distributed unit only if its interference level is determined to be above a predetermined threshold level.

### (Supplementary Note 13)

The method according to Supplementary note 12, wherein the third message comprises a configuration update message.

### (Supplementary Note 14)

The method according to Supplementary note 13, comprising receiving, from the distributed unit of the split base station apparatus, a fourth message comprising a specific response message for responding to the third message.

### (Supplementary Note 15)

The method according to Supplementary note 14, wherein the fourth message includes an information element, IE, for reporting an action taken by the distributed unit in response to the third message.

### (Supplementary Note 16)

The method according to Supplementary note 12, in the event that it is determined that interference in cells under control of one or more other base stations requires reduction, the central unit of the split base station apparatus is configured to send a cell interference list and/or one or more recommended actions to the central unit of the one or more other base station apparatuses over an Inter-base station interface.

### (Supplementary Note 17)

The method according to any of the preceding Supplementary notes, further comprising using one or more measurement values received in the second message from the distributed unit of the split base station apparatus to generate a list of UEs for which a handover, HO, is recommended and/or a list of cells/beams that require capacity improvement and, optionally, a list of potential interference source cells/beams.

### (Supplementary Note 18)

The method according to Supplementary note 17, comprising sending, to the distributed unit, recommendation data representative of recommended actions to be taken by the distributed unit to reduce interference levels, and optionally comprising receiving, from the distributed unit, action data representative of action taken by the distributed unit in response to the recommendation data to reduce interference levels.

### (Supplementary Note 19)

The method according to any preceding Supplementary notes, wherein the split base station apparatus comprises a fifth generation, 5G, base station, gNB, that operates according to 5G standards.

### (Supplementary Note 20)

A central unit of a split base station apparatus of a cellular communication system, the central unit comprising means for sending, to a distributed unit, DU, of the split base station apparatus that serves a user equipment, UE, a first message comprising an information element, IE, for configuring the distributed unit of the split base station apparatus to report current measurement data representative of communication quality measurements; and means for receiving, from the distributed unit of the split base station apparatus, in a second message sent in response to the first message, communication quality measurements for the cell and/or beam currently serving the UE under control of the distributed unit of the split base station apparatus.

### (Supplementary Note 21)

A distributed unit, DU, of a split base station apparatus that serves a user equipment, UE, in a cellular communication system, the distributed unit comprising means for receiving, from a central unit of the split base station apparatus, a first message comprising an information element, IE, for configuring the distributed unit to report current measurement data representative of communication quality measurements; and means for sending, to the central unit in response to the first message, a second message containing data representative of communication quality measurements for the cell and/or beam currently serving the UE under control of the distributed unit.

### (Supplementary Note 22)

A method performed by a distributed unit of a split base station of a cellular communication system, the method comprising: receiving, from a central unit of the split base station apparatus, a first message comprising an information element, IE, for configuring the distributed unit to report current measurement data representative of communication quality measurements; and sending, to the central unit in response to the first message, a second message containing data representative of communication quality measurements for the cell and/or beam currently serving the UE under control of the distributed unit.

### (Supplementary Note 23)

A base station apparatus comprising a central unit according to Supplementary note 20 and a distributed unit according to Supplementary note 21.

### (Supplementary Note 24)

A communication system comprising a plurality of UEs, at least one base station according to Supplementary note 23 and a core network.

### (Supplementary Note 25)

A computer implementable program product which, when loaded and run on programmable apparatus, causes the programmable apparatus to perform the method of any of Supplementary notes 1 to 19 and/or the method of Supplementary note 22.

It will be appreciated by a person skilled in the art that numerous variations and/or modifications may be made to the present disclosure as shown in the specific embodiments without departing from the spirit or scope of this disclosure as broadly described. The present embodiments are, therefore, to be considered in all respects to be illustrative and not restrictive. The present application is based upon and claims the benefit of priority from United Kingdom Patent Application No. 2100492.4, filed on Jan. 14, 2021, the entire contents of which are hereby incorporated by reference.

### REFERENCE SIGNS LIST

1 telecommunications system
3 user equipment
5, 5-1, 5-2 base station
5-2a, 5-2a-1, 5-2a-2, 5-2a-3 gNB-DU
5-2b gNB-CU
5-2b-1 gNB-CU-CP
5-2b-2 gNB-CU-UP
6-1, 6-2, 6-3 cell
7 core network
9 serving gateway (S-GW) or Session Management Function (SMF)
11 mobility management entity (MME) or Access and Mobility Function (AMF)
13 other EPC or 5GC nodes
231 transceiver circuit
233 antenna
235 interface
237 controller
239 memory
241 operating system
243 communications control module
245 measurement module
451a, 451b, 451c transceiver circuitry
453a antenna
454a, 454b, 454c interface
457a, 457b, 457c controller
459a, 459b, 459c memory
461a, 461b, 461c operating system
463a, 463b, 463c communications control module
464b E1 module
465a, 465b, 465c F1 module
467b Xn/X2 module
468b RRC module
469b CN interface module
471b SgNB operation module

What is claimed is:

1. A method performed by a central unit of a base station, the method comprising:
sending, to a distributed unit of the base station configured to serve a user equipment, UE, a first message for configuring the distributed unit to send current measurement data for a cell and/or a beam;
receiving, from the distributed unit, in a second message sent based on the first message, the current measurement data for a cell and/or a beam; and
sending, to the distributed unit, a configuration update message including at least a list of at least one cell which is affected by interference, and a list of at least one beam which is affected by interference.

2. The method according to claim 1, wherein the current measurement data includes uplink, UL, communication measurements.

3. The method according to claim 1, wherein
the first message includes a request message, and
the second message includes a response message based on the request message.

4. The method according to claim 1, wherein the first message includes a resource status request message, and
the second message includes a resource status update message based on the resource status request message.

5. (canceled)

6. The method according to claim 1, wherein the first message includes a bitmap including at least one bit indicating to request the distributed unit to provide the current measurement data.

7. The method according to claim 6, wherein
a first bit of the bitmap indicates to request the distributed unit to provide the current measurement data at beam level, and
a second bit of the bitmap indicates to request the distributed unit to provide the current measurement data at cell level.

8. The method according to claim 1, wherein
the second message includes data representing signal-to-interference signal-to-noise ratio, SINR, which is associated with a communication channel of the UE and which is obtained at signal-level, beam-level and/or cell-level.

9. The method according to claim 1, wherein the sending the first message is performed in response to receiving a UE measurement report from the UE.

10. The method according to claim 1, further comprising using the current measurement data to determine an overall interference level in each cell and/or beam currently under control of the distributed unit.

11. The method according to claim 1, further comprising determining an overall interference level in one or more neighbouring cells and/or beams.

12-13. (canceled)

14. The method according to claim 1, further comprising:
receiving, from the distributed unit, a configuration update acknowledgement message indicating at least one action taken by the distributed unit in response to the configuration update message.

15. (canceled)

16. The method according to claim 1, further comprising:
sending at least one of: a list of at least one cell which is affected by interference; and at least one recommended action to a respective central unit of at least one other base station over an Inter-base station interface, in a case where it is determined that interference in cells under control of the at least one other base station requires reduction.

17. The method according to claim 1, further comprising
using the current measurement data to generate at least one of:
a list of UEs for which a handover is recommended,
a list of cells/beams that require capacity improvement and,
a list of potential interference source cells/beams.

18. The method according to claim 17, further comprising:
sending, to the distributed unit, recommendation data indicating at least one recommended action to be taken by the distributed unit to reduce interference levels; and
receiving, from the distributed unit, action data indicating action taken by the distributed unit in response to the recommendation data.

19. A central unit of a base station, the central unit comprising:
a memory storing instructions; and
at least one processor configured to process the instructions to:
send, to a distributed unit of the base station configured to serve a user equipment, UE, a first message for configuring the distributed unit to send current measurement data for a cell and/or a beam;
receive, from the distributed unit, in a second message sent based on the first message, the current measurement data for a cell and/or a beam; and
send, to the distributed unit, a configuration update message including at least a list of at least one cell which is affected by interference, and a list of at least one beam which is affected by interference.

20-22. (canceled)

23. A method performed by a distributed unit of a base station configured to serve a user equipment, UE, the method comprising:
receiving, from a central unit of the base station, a first message for configuring the distributed unit to send current measurement data for a cell and/or a beam;
sending, to the central unit, based on the first message, a second message including the current measurement data for a cell and/or a beam; and
receiving, from the central unit, a configuration update message including at least a list of at least one cell which is affected by interference, and a list of at least one beam which is affected by interference.

24. A distributed unit of a base station configured to serve a user equipment, UE, the distributed unit comprising:
a memory storing instructions;
at least one processor configured to process the instructions to:
receive, from a central unit of the base station, a first message for configuring the distributed unit to send current measurement data for a cell and/or a beam; and
send, to the central unit, based on the first message, a second message including the current measurement data for a cell and/or a beam; and
receive, from the central unit, a configuration update message including at least a list of at least one cell which is affected by interference, and a list of at least one beam which is affected by interference.
